(19) United States
(12) Patent Application Publication
(10) Pub. No.: US 2008/0145486 A1
(43) Pub. Date: Jun. 19, 2008

(54) Water continuous frying composition

(75) Inventor: Wim Theodorus Hogervorst, Vlaardingen (NL)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Conopco Inc, d/b/a UNILEVER

(21) Appl. No.: 12/002,627

(22) Filed: Dec. 18, 2007

(30) Foreign Application Priority Data
Dec. 19, 2006 (EP) EP06126532

(51) Int. Cl. A23D 7/005; A23L 1/00; A23P 1/00

(52) U.S. Cl. 426/96; 426/665; 426/489

(57) ABSTRACT

Water-continuous composition comprising 75 to 90 wt % liquid oil, comprising 0.05 to 5 wt. % of a porous powderous vegetable matter made from nuts, seeds, beans kernels, pits and cellulose having a volume weighted mean particle diameter (d_{4,3}) not exceeding 0.5 mm.

### TECHNICAL FIELD

The invention relates to oil-in-water emulsion food products, in particular spreads showing a good spattering behaviour when used in shallow frying.

### BACKGROUND

Frying composition are compositions that are used for frying food. Common frying agents such as butter or margarine are fat continuous. However, these fat continuous often suffer from spattering which is believed to be caused by superheating of the dispersed water droplets. In addition, fat continuous emulsion spreads and liquid products are poor in physical stability at elevated temperatures e.g. above 30° C. Another drawback from fat continuous frying compositions is the use of hardstock fat which gives the frying composition a high level of saturated fatty acids which are not desirable from a health perspective. Furthermore, the use of hardstock fat requires high energy processing due to the necessary liquefying of the hardstock fat in the process.

Water continuous frying emulsions are also known e.g. from WO02/45519. However, water continuous frying emulsions often contain salt and lecithin, and a high level of emulsifiers. The effect of sole lecithin on spattering is small, therefore a substantial amount of salt exceeding 0.3 wt. % should be added to get good spattering behaviour. In current trends in healthy lifestyles, a lower sodium content for food products is often desired, as high salt levels are associated with high blood pressure. Furthermore the water continuous frying composition often foam considerably which is not desirable from a consumer's perspective. In addition, the water continuous frying composition are often pourable.

A relatively high salt content is typical for most prior art cooking oils which show an improved spattering behaviour. The presently available alternatives for lecithin and cooking salt consist of non-natural substances.

For the consumer it is not always easy to know when the frying composition is ready to use for shallow frying (i.e. when to add the food product to be fried to the heated frying composition). The changes in the development of foaming when heating water continuous frying compositions provide the consumer with a visual cue when the composition is ready to use for shallow frying. Typically the composition starts foaming after a certain time of heating the composition. When no considerable amount of foaming is seen anymore the composition is ready to use for shallow frying. It is desired that the composition can be used as quick as possible after starting to heat the composition.

H. Pardun, in Fette,Seifen, Anstrichmittel 79(5), 1977, pp. 195-203 describes the use of milled soy protein concentrates as antispattering agents in margarines. The antispattering agents proposed by Pardun have the disadvantage that when heated in the pan during shallow frying, they may decompose and give char formation. Moreover, we have found that when margarines of Pardun are prepared using modern margarine equipment, such as a votator, the antispattering agents are no longer effective.

WO2005/058067 and WO2005/013056 disclose fat continuous frying compositions with improved spattering behaviour that comprise porous powderous vegetable matter made from nuts, seeds kernels, pits and cellulose having a volume weighted mean particle diameter (d_{4,3}) not exceeding 0.5 mm.

In developing countries a multipurpose frying composition is preferred. Consumers in these countries prefer a product that can both be used as a spread and as a frying composition. Moreover, ambient stable compositions are favoured because these do not need a refrigerator.

There is therefore a need for a frying composition that has excellent spattering behaviour and is multipurpose, i.e. may also being used as a spread. Furthermore nutritional benefits as low salt, and low saturated fatty acid content desired. Preferably the frying composition has less foaming and uses less additives. In addition, ambient stability is also sought after. Moreover a cold processing of the frying composition has benefits as it uses less energy than high energy processes. Furthermore, the composition preferable provides a visual cue that shows when the composition is ready to use. Preferably the composition is ready to use for frying relatively quick.

### SUMMARY OF THE INVENTION

It is an object to provide a product having a good spattering performance in shallow frying. A further object is to provide healthy frying product, in particular having a low amount of salt, and a low amount of SAFA. Another object of the invention is to provide a frying product that does not brown or give of-taste or leave a sediment or foams upon heating to high temperatures. In addition, a further object of the invention is to provide a frying product that needs less ingredients, such as emulsifiers. Moreover, another object of the invention is to provide a frying product that can be made by cold processing using less energy. Furthermore another object of the invention is to provide a frying product that may also be used as a spread. In addition an object of the invention is to provide ambient stable products. Furthermore it is an object of the invention to provide a frying product that provides a visual cue. It is also an object of the invention to provide a frying product that is ready to use for frying in a shorter amount of time.

One or more of these objects are attained according to the invention which provides an oil-in-water emulsion food product comprising 75 to 90 wt % liquid oil and 0.05-5 wt % of a porous powderous vegetable matter made from nuts, seeds, kernels, pits and cellulose having a volume weighted mean particle diameter (d4,3) not exceeding 0.5 mm.

### DETAILS OF THE INVENTION

The composition is preferably a spread. The expression spread is intended to mean a plastic, spreadable product which can be applied onto bread in an even layer without tearing the bread. Preferably the spreads are ambient stable and do not become much softer at higher temperatures.

Suitably the porous powderous vegetable matter is evenly dispersed throughout one or more phases of the water continuous composition. Preferably the volume weighted mean particle diameter (d_{4,3}) of the porous powderous vegetable matter does not exceed 0.1 mm, preferably not 0.04 mm.

The composition according to the invention may comprise an additional antispattering agent. These antispatter agents are the known antispatter agents such as salt and lecithin.

Preferably the additional antispattering agent comprises salt in an amount of from 0.1 to 5 wt % on total weight of the composition and a lecithin in an amount of from 0.05 to 2 wt % on total weight of the composition.

Preferably the pH is between 3 and 8.

Preferred compositions comprise a biopolymer. Suitably the biopolymer is present in an amount of from 0.01 to 0.3 wt %.

Suitable composition according to the invention wherein the fat is dispersed in a water phase, have an average droplet size (d_{4,3}) of the fat of less than 12, preferably less than 8 μm, more preferably less than 6 μm, most preferred from 0.35 to 4 μm.

Composition according to the invention may comprise at least one emulsifier having a hydrophilic/lipophilic balance value of at least 7. Suitably the amount of emulsifier comprises 0.1 to 5 wt % on product.

Suitable emulsifier are selected from the group comprising di-acetyl tartaric acid esters of monoglycerides and/or diglycerides (DATEM), polyoxyethylene sorbitan monostearate (Tween), sucrose esters, sodium stearoyl lactylate (SSL), polygycerol esters (PGE), acetylated pectin, esters of citric acid with monoglycerides and/or with diglycerides, lactic acid esters of mono-and/or diglycerides, succinic acid esters of mono-and/or diglycerides; or combinations thereof.

A preferred emulsifier is DATEM. When DATEM is used it is preferably used in an amount of from 0.3 to 3 wt %.

In a preferred embodiment of the present invention 0.4-1.0 wt. % of the porous powderous vegetable matter is admixed to the water continuous composition.

Preferred porous powderous vegetable matter consists of milled kernels of olive oil.

In another preferred embodiment the porous powderous vegetable matter consists of milled sunflower seeds or milled linseeds.

In yet another preferred embodiment the porous powderous vegetable matter consists of milled soybeans.

Furthermore other suitable porous powderous vegetable matter consists of milled nuts selected from the group consisting of pine tree nuts, almonds, ground nuts, walnuts and cashew nuts.

Preferred compositions according to the invention are substantially free from cooking salt preferably below 0.9 wt %, more preferably below 0.5 wt %.

The oil-in-water emulsion food products according to the present invention may be produced according to a process which comprises the following steps:

a. selecting an oil-in-water emulsion

b. selecting emulsion insoluble vegetable matter having a consistency which allows milling to a powder,

c. milling the vegetable matter to a powder having an average particle size not exceeding 0.5 mm,

d. admixing the resulting powder to the oil-in-water emulsion in an amount of 0.05-5 wt. % on product and getting it evenly dispersed throughout the oil-in-water emulsion.

Preferably the process for the preparation of the composition according to the invention involves at least one process step in which the pressure is 0.20 MPa or more and wherein the porous powderous vegetable matter is not subjected to any pressure of 0.20 MPa or more.

Suitably the porous powderous vegetable matter is prepared by milling vegetable matter. Preferably the porous powderous vegetable matter is prepared by milling and extracting oil from oil containing vegetable matter. Preferably the extraction is done with an organic solvent. Suitably the vegetable matter is pre-milled, oil-extracted and then the extracted vegetable matter is milled to prepare the porous powdered vegetable matter.

Experimental:

Protocol for Measurement of Stevens Values

Hardness is a very relevant spread property. It is expressed as a Stevens value and established with standard measuring equipment.

For assessment a Stevens-LFRA Texture Analyser (ex Stevens Advanced Weighing Systems, Dunmore, U.K.) is used. The so-called “Stevens_{4.4}” hardness S(t) at temperature t is expressed in grams. Measurement specifications: 4.4 mm diameter probehead cylinder; load range 1000 g; device operated “normal” and set at 10 mm penetration depth and 1 mm/sec penetration rate. Before measuring the spread is equilibrated at the measuring temperature for 24 hours.

### EXAMPLE 1

Preparation of an Edible Oil-In-Water Emulsion

A frying composition was prepared with the composition shown in table.

TABLE 1
Composition of a 80 wt. % fat frying composition

| | Amount |
|---|---|
| Ingredient | (wt. %) |
| Oil phase | |
| Sunflower oil | 79.5 |
| Polyoxyethylene sorbitan monostearate | 0.2 |
| (emulsifier) | |
| Fractionated lecithin Cetinol | 0.3 |
| Water phase | |
| Sodium chloride | 1.2 |
| Xanthan gum | 0.15 |
| Beta-carotene solution in water | 0.075 |
| Potassium Sorbate | 0.1 |
| Soy flour | 0.1 |
| Citric Acid Anhydrate | 0.038 |
| Water | Up to 100 wt % |

Preparation of Frying Composition

The following procedure was followed:

The water phase was prepared by dissolving all water-soluble ingredients in de-mineralised water at 25° C. Firstly the Xanthan gum is dissolved in the water phase, after this the other water phase ingredients are dissolved. Citric Acid Anhydrate is dissolved in the water phase as the last ingredient while stirring with an Ultra Turrax device or directly in a Colloidmill. The oil phase used for the emulsion was prepared by dissolving the oil soluble components in sunflower oil. The ingredients are dissolved in sunflower oil at a temperature of approx. 65° C.

The oil phase was added to the water phase in the Colloidmill, while stirring to keep the emulsion water-continuous. After addition of the oil phase the emulsion was stirred for 5 min. at high speed in the Colloidmill.

The spattering values of the frying compositions are given in table 2.

Comparative Experiment A

Example 1 is repeated, but now without soy flour. The spattering values of the frying composition are given in table 2.

Determination of Spattering Value

Primary spattering (SV1) was assessed under standardised conditions in which an aliquot of a food product was heated in a glass dish and the amount of fat spattered onto a sheet of paper held above the dish was assessed after the water content of the food product had been driven off by heating.

Secondary spattering (SV2) was assessed under standardised conditions in which the amount of fat spattered onto a sheet of paper held above the dish is assessed after injection of a quantity of 10 ml water into the dish.

In assessment of both primary and secondary spattering value about 25 g food product was heated in a glass dish on an electric plate to about 205° C. The fat that spattered out of the pan by force of expanding evaporating water droplets was caught on a sheet of paper situated above the pan. The image obtained was compared with a set of standard pictures number 0-10 whereby the number of the best resembling picture was recorded as the spattering value. 10 indicates no spattering and zero indicates very bad spattering. The general indication is as follows.

| Score | Comments |
|---|---|
| 10 | excellent |
| 8 | good |
| 6 | passable |
| 4 | unsatisfactory for SV1, almost passable for SV2 |
| 2 | very poor |

Typical results for household margarines (80 wt % fat) are 8 for primary spattering (SV1) and 5 for secondary spattering (SV2) under the conditions of the above mentioned test.

TABLE 2
spattering behaviour of frying compositions

| | Fat content of | | | | |
|---|---|---|---|---|---|
| | emulsion product | Amount of soy | | | |
| Example | (wt. %) | flour (wt. %) | SV1 | SV2 | S5 |
| 1 | 80 | 0.1 | 8 | 7 | 20 g |
| A | 80 | 0 | 7.5 | 5 | 451 |

As can be seen the products according to the invention have an excellent spattering behaviour especially for the secondary spattering value.

1. Water-continuous composition comprising 75 to 90 wt % liquid oil, comprising 0.05 to 5 wt. % of a porous powderous vegetable matter made from nuts, seeds, beans kernels, pits and cellulose having a volume weighted mean particle diameter (d_{4,3}) not exceeding 0.5 mm.

2. Composition according to claim 1 having a stevens value at 5° C. of about 100 to 500 g.

3. Composition according to claim 1 comprising at least one emulsifier having a hydrophilic/lipophilic balance value of at least 7.

4. Composition according to claim 3 comprising 0.1 to 5 wt % of emulsifier.

5. Composition according to claim 4 comprising an emulsifier selected from the group comprising di-acetyl tartaric acid esters of monoglycerides and/or diglycerides. (DATEM), polyoxyethylene sorbitan fatty acid esters (Tween), sucrose esters, sodium stearoyl lactylate (SSL), polygycerol esters (PGE), acetylated pectin, esters of citric acid with monoglycerides and/or with diglycerides, lactic acid esters of mono-and/or diglycerides, succinic acid esters of mono-and/or diglycerides; or combinations thereof.

6. Composition according to claim 5 wherein the emulsifier is DATEM in a preferred amount of from 0.3 to 3 wt %.

7. Composition according to claim 1 comprising a biopolymer in an amount of 0.05 to 0.3 wt % on total composition weight.

8. Composition according to claim 1 comprising an additional antispattering agent.

9. Composition according to claim 1 wherein the volume weighted mean particle diameter (d_{4,3}) of the porous powderous vegetable matter does not exceed 0.1 mm, preferably not 0.04 mm.

10. Composition according to claim 1 wherein 0.4-1.0 wt. % of the porous powderous vegetable matter is admixed to the water continuous Composition.

11. Composition according to claim 1, wherein the porous powderous vegetable matter consists of milled kernels of olive oil.

12. Composition according to claim 1, wherein the porous powderous vegetable matter consists of milled sunflower seeds or milled linseeds.

13. Composition according to claim 1, wherein the porous powderous vegetable matter consists of milled soybeans.

14. Composition according to claim 1, wherein the porous powderous vegetable matter consists of milled nuts selected from the group consisting of pine tree nuts, almonds, ground nuts, walnuts and cashew nuts.

15. Composition according to claim 1, wherein the water-continuous composition is substantially free from cooking salt preferably below 0.9 wt %, more preferably below 0.5 wt %.

16. Process for the preparation of a water continuous food product comprising porous powderous vegetable matter having a volume weighted mean particle diameter (d_{4,3}) not exceeding 0.5 mm, wherein the process involves at least one process step in which the pressure is 0.20 MPa or more and wherein the porous powderous vegetable matter is not subjected to any pressure of 0.20 MPa or more.

17. Process according to claim 16, wherein the porous powderous vegetable matter is prepared by milling vegetable matter.

18. Process according to claim 17, wherein the porous powderous vegetable matter is prepared by milling and extracting oil from oil containing vegetable matter.

19. Process according to claim 16, wherein the porous powderdous vegetable matter is prepared by milling vegetable matter, which has been extracted with an organic solvent.

20. Process according to claim 16, wherein the vegetable matter is pre-milled, oil-extracted and then the extracted vegetable matter is milled to prepare the porous powdered vegetable matter.
